(19) United States
(12) Patent Application Publication
(10) Pub. No.: US 2004/0247101 A1
(43) Pub. Date: Dec. 9, 2004

(54) Telephone

(76) Inventor: Bernard Dumoulin, Roeschwoog (FR)

Correspondence Address: BELL, BOYD & LLOYD, LLC, P. O. BOX 1135, CHICAGO, IL, 60690-1135, US

(21) Appl. No.: 10/485,789

(22) PCT Filed: Jul. 16, 2002
(86) PCT No.: PCT/DE02/02603

(51) Int. Cl. H04M 1/56; H04M 15/06

(52) U.S. Cl. 379/142.01

(57) ABSTRACT

A telephone is provided which includes a processor device which is set up in such a way that the phone number of a caller is automatically displayed during a telephone connection.

### BACKGROUND OF THE INVENTION

The present invention relates to a telephone having a display unit, a memory device and a processor device.

Rapid technical development in the field of mobile communications has, in recent years, led to the development and provision of a multiplicity of different mobile telephones. The “man-machine interface” is also at the center of development since simple and intuitive operation of a mobile telephone and its variety of functions may promote further dissemination of mobile communications.

In this case, it is known practice, during a telephone call, to display, on a display of a mobile telephone, the telephone number of a second mobile telephone to which there is currently a telephone connection.

Currently, since mobile telephone numbers frequently include a large number of digits, many users are frequently confronted with the problem of, during a call, wanting to give the communication partner information on their own telephone number but are unable to do so because they cannot recite their own telephone number from memory. Although mobile telephones which have been provided with an electronic telephone book (which also contains an entry of the telephone's own telephone number) are available, it is too complicated or even impossible for most users to call up this telephone number during an existing telephone connection.

The present invention is, therefore, directed toward a telephone which, in a simple manner, makes it possible for a user to give information on his/her own telephone number during a telephone connection.

### SUMMARY OF THE INVENTION

According to the present invention, the processor device in a telephone is set up in such a manner that the telephone number of the telephone is automatically displayed during a telephone connection.

As a result, by quickly glancing at the display unit on his/her telephone, a user can find out his/her telephone number and give information on it during a telephone connection.

Further embodiments of the present invention provide particularly intuitive variants for displaying the telephone number, particularly in combination with additional information as well.

Additional features and advantages of the present invention are described in, and will be apparent from, the following Detailed Description of the Invention and the Figures.

### BRIEF DESCRIPTION OF THE FIGURES

FIG. 1 shows a basic block diagram of a mobile station in association with the present invention.

### DETAILED DESCRIPTION OF THE INVENTION

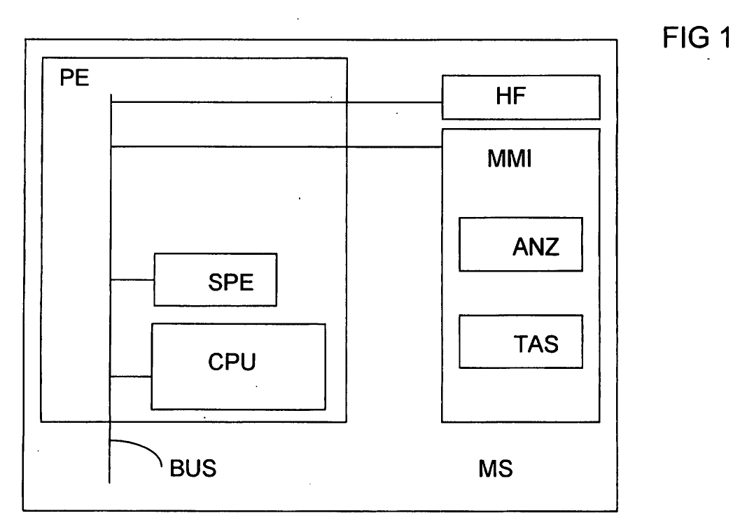

FIG. 1 shows, as a telephone, a mobile station MS containing a control device MMI, a radio-frequency device HF and a processor device PE. The control device MMI includes a display device ANZ, such as a graphics display, and operating elements, such as buttons or softkeys. The control device MMI also may be in the form of a touchscreen. A program-controlled processor device PE, such as a microcontroller, which also may include a processor CPU and a memory device SPE, is provided for the purpose of controlling the mobile station MS and the processes which are carried out by the mobile station.

Depending on the particular embodiment, additional components which are associated with the processor device, which belong to the processor device, which are controlled by the processor device or which control the processor device, such as a digital signal processor or additional memory devices, may be arranged either inside or outside the processor device PE. The basic operation of such additional components (in connection with a processor device for controlling a mobile station) is sufficiently well known to a person skilled in the art and, thus, is not discussed in any more detail at this juncture. The various components may interchange data with the processor CPU via a bus system BUS or input/output interfaces and, if need be, suitable controllers.

Also depending on the particular embodiment, the memory device SPE (which also may be one or more volatile and/or nonvolatile memory modules) or parts of the memory device SPE may be part of the processor device PE (shown in FIG. 1) or may be an external memory device (not shown in FIG. 1) which is located outside the processor device PE and is connected to the processor device PE via suitable interfaces or a suitable bus system. The memory device also may be embodied, at least partially, as a subscriber identity module.

The memory device SPE stores the program data, such as the control commands or control procedures, which are used to control the mobile station. In addition, the memory device SPE stores telephone numbers, particularly the telephone number of the telephone itself. In this case, the telephone number of the telephone is also understood to be the telephone user's telephone number which may be defined by the telephone number associated with the user's subscriber identity module. In one embodiment of the present invention, the telephone number of the telephone is stored in the subscriber identity module.

The processor device in the telephone is set up in such a manner that, during a telephone call or a telephone connection between the telephone and a second telephone, the telephone number of the telephone is automatically displayed on the display unit. The telephone connection also may be a mobile radio connection, a landline network connection, a voice-over-IP connection or a combination of these different types of connection. Automatic display of the telephone number of the telephone also may be triggered in this case by accepting an incoming call, by initiating a connection set-up by pressing a corresponding connection set-up button or by terminating a connection set-up; that is to say, the existence of a connection.

Depending on the particular embodiment, the telephone number of the telephone may be displayed at the same time as, or alternately with, other information such as the telephone number of the second telephone or the duration of the telephone connection.

In addition to the various embodiments of the present invention which have been explained above, the present invention covers a multiplicity of other design variants which are not described further here, but which may be put into practice in a relatively simple manner with reference to the exemplary embodiments explained.

Indeed, although the present invention has been described with reference to specific embodiments, those of skill in the art will recognize that changes may be made thereto without departing from the spirit and scope of the present invention as set forth in the hereafter appended claims.

1-3. canceled.

4. A telephone, comprising:
a display unit for displaying a telephone number;
a memory device for storing a telephone number of the telephone; and
a processor device for effecting an automatic display of the telephone number of the telephone on the display unit after a telephone connection has been set up between the telephone and a second telephone.

5. A telephone as claimed in claim 4, wherein the telephone number of the telephone and a telephone number of the second phone are displayed in a manner which is one of simultaneously and alternately.

6. A telephone as claimed in claim 4, wherein the telephone number of the telephone and information regarding a duration of the telephone connection are displayed in a manner which is one of simultaneously and alternately.

7. A telephone as claimed in claim 4, wherein the telephone number of the telephone, a telephone number of the second telephone and information regarding a duration of the telephone connection are displayed in a manner which is one of simultaneously and alternately.

8. A telephone as claimed in claim 4, wherein the memory device is at least partially embodied as a subscriber identity module, with the telephone number of the telephone being a user telephone number which is defined by, and stored in, the subscriber identity module.

9. A telephone, comprising:
a display unit for displaying a telephone number;
a memory device for storing a telephone number of the telephone; and
a processor device for effecting an automatic display of the telephone number of the telephone on the display unit after an operating element for setting up a telephone connection between the telephone and a second telephone has been operated.

10. A telephone as claimed in claim 9, wherein the telephone number of the telephone and a telephone number of the second telephone are displayed in a manner which is one of simultaneously and alternately.

11. A telephone as claimed in claim 9, wherein the telephone number of the telephone and information regarding a duration of the telephone connection are displayed in a manner which is one of simultaneously and alternately.

12. A telephone as claimed in claim 9, wherein the telephone number of the telephone, a telephone number of the second telephone and information regarding a duration of the telephone connection are displayed in a manner which is one of simultaneously and alternately.

13. A telephone as claimed in claim 9, wherein the memory device is at least partially embodied as a subscriber identify module, with the telephone number of the telephone being a user telephone number which is defined by, and stored in, the subscriber identity module.
